(19) United States
(12) Patent Application Publication
(10) Pub. No.: US 2022/0374498 A1
(43) Pub. Date: Nov. 24, 2022

(54) DATA PROCESSING METHOD OF DETECTING AND RECOVERING MISSING VALUES, OUTLIERS AND PATTERNS IN TENSOR STREAM DATA

(71) Applicant: Samsung Electronics Co., Ltd., Suwon-si (KR)

(72) Inventors: Changwook JEONG, Hwaseong-si (KR); Dongjin LEE, Daejeon (KR); Kijung SHIN, Daejeon (KR)

(73) Assignees: Samsung Electronics Co., Ltd., Suwon-si (KR); KOREA ADVANCED INSTITUTE OF SCIENCE AND TECHNOLOGY, Daejeon (KR)

(21) Appl. No.: 17/672,060

(22) Filed: Feb. 15, 2022

(30) Foreign Application Priority Data
Apr. 21, 2021 (KR) 10-2021-0051577

(51) Int. Cl. G06F 17/16

(52) U.S. Cl. CPC G06F 17/16

(57) ABSTRACT

A tensor data processing method is provided. The method comprises receiving an input tensor including at least one of an outlier and a missing value, the input tensor being input during a time interval between a first time point and a second time point, factorizing the input tensor into a low rank tensor to extract a temporal factor matrix, calculating trend and periodic pattern from the extracted temporal factor matrix, detecting the outlier which is out of the calculated trend and periodic pattern, updating the temporal factor matrix except the detected outlier, combining the updated temporal factor matrix and a non-temporal factor matrix of the input tensor to calculate the real tensor and recovering the input tensor by setting data corresponding to a position of the outlier or a position of the missing value of the input tensor from the data of the real tensor as an estimated value.

### CROSS-REFERENCE TO RELATED APPLICATION

This application claims priority from Korean Patent Application No. 10-2021-0051577 filed on Apr. 21, 2021 in the Korean Intellectual Property Office, and all the benefits accruing therefrom under 35 U.S.C. 119, the contents of which in its entirety are herein incorporated by reference.

### BACKGROUND

### 1. Field

The present inventive concepts relate to a data processing method of tensor stream data.

### 2. Description of the Related Art

Tensors are representation of multi-way data in a high-dimensional array. Data modeled as tensors are used in various fields, such as machine learning, urban computing, chemometrics, image processing, and recommender systems.

As the dimension and/or size of data increase, extensive research has been conducted on tensor factorization which may effectively analyze tensors.

The real data may include outliers due to causes such as network disconnection and system errors, or some of data may be lost. The tensor factorization based on tensors contaminated with such outliers and lost data is relatively inaccurate, and it is not easy to recover tensors contaminated with such outliers and loss data after tensor factorization.

### SUMMARY

Aspects of the present inventive concepts provide a tensor data processing method of detecting outliers and restoring missing values on the basis of the characteristics of the tensor stream data.

Aspects of the present inventive concepts also provide a tensor data processing method capable of predicting future tensor data.

Example embodiments of the present inventive concepts provide a tensor data processing method, the method comprises receiving an input tensor including at least one of an outlier and a missing value, the input tensor being input during a time interval between a first time point and a second time point, factorizing the input tensor into a low rank tensor to extract a temporal factor matrix, calculating trend and periodic pattern from the extracted temporal factor matrix, detecting the outlier which is out of the calculated trend and periodic pattern, updating the temporal factor matrix except the detected outlier, combining the updated temporal factor matrix and a non-temporal factor matrix of the input tensor to calculate the real tensor and recovering the input tensor by setting data corresponding to a position of the outlier or a position of the missing value of the input tensor from the data of the real tensor as an estimated value.

Example embodiments of the present inventive concepts provide a tensor data processing method, the method comprises receiving an input tensor, applying to the input tensor to initialize a static tensor factorization model of temporal characteristics, factorizing the input tensor into a temporal factor matrix and a non-temporal factor matrix on the basis of the static tensor factorization model, calculating trend and periodic pattern of the temporal factor matrix on the basis of the temporal prediction model, updating the temporal factor matrix and the non-temporal factor matrix in accordance with a dynamic tensor factorization model, combining the updated temporal factor matrix and the non-temporal factor matrix to calculate the real tensor and detecting and repairing an outlier tensor and a missing value of the input tensor on the basis of the real tensor.

Example embodiments of the present inventive concepts provide a tensor data processing method, the method comprises receiving an input tensor including at least one of an outlier and a missing value, the input tensor being input during a time interval between a first time point and a second time point, factorizing the input tensor into a low rank tensor to extract each factor matrix, calculating each data pattern from the extracted first temporal factor matrix, detecting the outlier which is out of the calculated data pattern from the first factor matrix, updating the first factor matrix on the basis of the calculated data pattern except the detected outlier, combining the updated first factor matrix with a remaining second factor matrix of the input tensor to calculate the real tensor and recovering the input tensor by considering to a position of the outlier or a position of the missing value of the input tensor from the data of the real tensor as an estimated value.

However, aspects of the present inventive concepts are not restricted to the one set forth herein. The aspects of the present inventive concepts will become more apparent to one of ordinary skill in the art to which the present inventive concepts pertain by referencing the detailed description of the present inventive concepts given below.

### BRIEF DESCRIPTION OF THE DRAWINGS

FIG. 1 is a conceptual diagram for explaining a high-dimensional tensor.

FIG. 2 is a conceptual diagram for explaining the tensor factorization of the high-dimensional tensor.

FIG. 3 is a graph for explaining the characteristics of the data pattern.

FIGS. 4 to 10 are conceptual diagrams for explaining a tensor data processing method of the present inventive concepts.

FIG. 11 is a flow chart explaining tensor data processing method.

FIGS. 12 to 14 illustrate simulation results of the tensor data processing method of the present inventive concepts.

FIG. 15 illustrates an embodiment of an electronic apparatus of the present inventive concepts.

### DETAILED DESCRIPTION OF EXAMPLE EMBODIMENTS

Unless otherwise specified, all terms used herein (including technical and scientific terms) may be used in the meaning that may be commonly understood by those having ordinary knowledge in the art to which the present inventive concepts belong. Also, terms commonly used and predefined are not ideally or excessively interpreted unless explicitly specifically defined.

Prior to specific explanation of example embodiments of the present inventive concepts, notations described in the present specification will be described.

Codes and indexes described herein are based on Table 1. For example, u is a scalar, u is a vector, U is a matrix, and x is a tensor. An N-dimensional tensor x indicates an (i₁, . . . , i_{N})-th input xᵢ_{₁}_{, . . . , i}_{_{N}} of N dimensions. In example embodiments, n indicates a dimension, which is a natural number from 1 to N, and i means an n-dimensional length, which has a range of 1≤iₙ≤I_{N}. Each matrix U indicates an element uᵢⱼ including an i-th row vector uᵢ and a j-th column vector uⱼ.

TABLE 1

| | |
|---|---|
| Symbol | Definition |

Notations for Tensors, Matrices, and Vectors (Sections III-A and III-B)

| | |
|---|---|
| u, u, U, χ | scalar, vector, matrix, tensor |
| uᵢ_{₁}, uᵢ_{₁}ᵢ_{₂} | i₁-th entry of u and (i₁, i₂)-th enrty of U |
| xᵢ_{₁} _{. . . i}_{_{N}} | (i₁ . . . i_{N})-th entry of χ |
| uᵢ, ũᵢ | i-th row and column vectors of U |
| U^{T}, U⁻¹, U^{†} | transpose, inverse, and pseudoinverse of U |
| \|\|U\|\|_{F} | Frobenius norm of U |
| X₍ₙ₎ | mode-n unfolding matrix of χ |
| ⊙ | Khatri-Rao product |
| [symbol] | Hadamard product |
| [[•]] | Kruskal operator |

Notations for the Holt-Winters Method (Sections III-C and III-D)

| | |
|---|---|
| lₜ, bₜ, sₜ | level, trend, and seasonal components at time t |
| α, β, γ | smoothing parameters corresponding to the level, |
| | trend, and seasonal components |
| \hat{σ}ₜ | scale of one-step-ahead forecast error at time t |
| Ψ(•), ρ(•) | Huber Ψ-function and biweight ρ-function |

Notations for SOFIA (Sections IV and V)

| | |
|---|---|
| y, yₜ | input tensor and input subtensor at time t |
| Ω, Ωₜ | indicator tensor and indicator subtensor at time t |
| [symbol] , [symbol] ₜ | outlier tensor and outlier subtensor at time t |
| L₁, Lₘ | temporal and seasonal smoothness constraint matrices |
| U⁽ⁿ⁾ | mode-n factor matrix |
| \hat{Σ}ₜ | one-step-ahead forecast error scale tensor at time t |
| R | rank of CP factorization |
| m | seasonal period |
| μ | gradient step size |
| ϕ | smoothing parameter for \hat{Σₜ} |
| λ₁ | temporal smoothness control parameter |
| λ₂ | seasonal smoothness control parameter |
| λ₃ | sparsity control parameter for [symbol] and [symbol] ₜ |

U [symbol] W indicates a Hadamard Product of matrices U and W of the same size. Sequence U^{(N)} [symbol] . . . [symbol] U⁽¹⁾ of Hadamard Product of matrix U may be represented by [symbol] ₙ₌₁^{N}U⁽ⁿ⁾. Hadamard Product may be extended to tensors.

U⊙W indicates Khatri-Rao Product of matrices U and W of the same size. The Khatri-Rao Product of the matrix U and the matrix W may be represented by Equation (1). Sequence U^{(N)}⊙ . . . ⊙U⁽¹⁾ of Khatri-Rao Matrix U may be represented by ⊙ₙ₌₁^{N}U⁽ⁿ⁾.

$$U ⊙ W = [ \begin{matrix}{u}_{11} {\tilde{w}}_{1} & {u}_{12} {\tilde{w}}_{2} & … & {u}_{1 R} {\tilde{w}}_{R} \\ {u}_{21} {\tilde{w}}_{1} & {u}_{22} {\tilde{w}}_{2} & … & {u}_{2 R} {\tilde{w}}_{R} \\ ⋮ & ⋮ & ⋱ & ⋮ \\ {u}_{I 1} {\tilde{w}}_{1} & {u}_{I 2} {\tilde{w}}_{2} & … & {u}_{I R} {\tilde{w}}_{R}\end{matrix} ] . \qquad ( 1 )$$

Hereinafter, example embodiments according to the technical idea of the present inventive concepts will be described referring to the accompanying drawings.

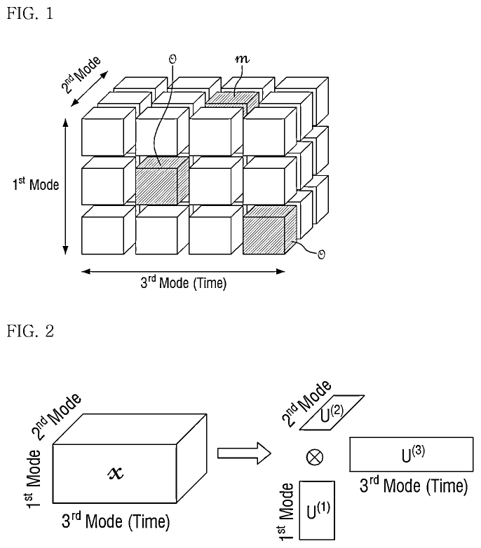

FIG. 1 is a conceptual diagram for explaining a high-dimensional tensor.

The tensor is a representation of data in a multi-dimensional array. For example, a vector is called a rank 1 tensor, a matrix is called a rank 2 tensor, and an array of three or more dimensions is called a rank-n tensor. Various real data may be expressed in the form of tensors.

Referring to FIG. 1, when recording the number of taxi operations from a departure point to a destination with time, each axis, for example, mode 1 is a vector indicating the direction and distance from the departure point, mode 2 is a vector indicating the direction and distance from destination, and mode 3 may indicate an elapsed time.

On the other hand, in many applications, tensor data may be collected in the form of tensor streams that continuously increase over time. However, the real data collected in the form of the tensor stream may include missing value (m of FIG. 1) and outlier (o of FIG. 1) due to network disconnection and system errors.

For example, a tensor x is a Rank 1 tensor that may be expressed as an outer product of N vectors. (For example, χ=u⁽¹⁾○u⁽²⁾○ . . . ○u^{(N)}, where u⁽ⁿ⁾∈ [symbol] ^{I}^{ₙ}) Rank 1 tensor may be described as a one-dimensional vector with size and direction. The outer product of the Rank 1 tensor may be represented by (u⁽¹⁾○u⁽²⁾○ . . . ○u^{(N)})ᵢ_{₁}_{. . . i}_{_{N}}=uᵢ_{₁}⁽¹⁾ . . . uᵢ_{_{N}}^{(N)}, in example embodiments, there is a relation of 1≤n≤N, 1≤iₙ≤I_{N}.

The present inventive concepts disclose a tensor data processing method of detecting missing values and outliers included in the tensor stream data in real time. The present invention also discloses a tensor data processing method of recovering missing values and outliers detected in a previous tensor stream received before. The present inventive concepts also disclose a tensor data processing method capable of predicting a future tensor stream to be received later.

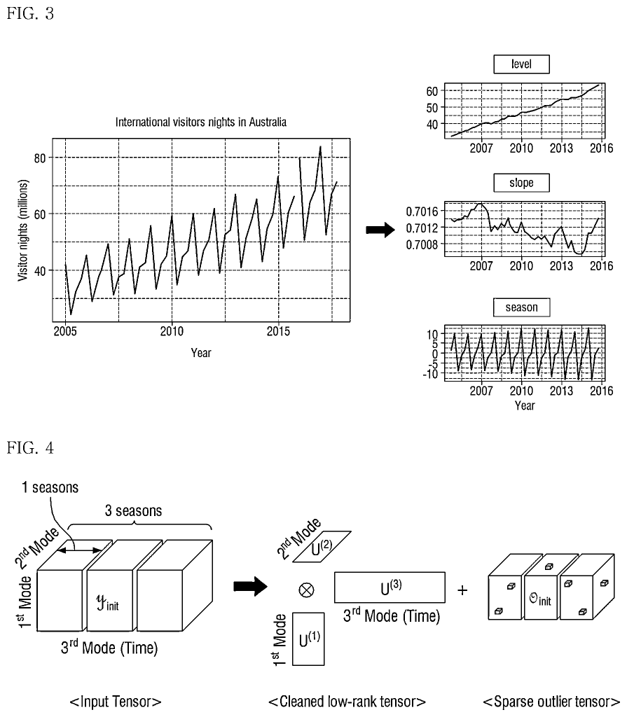

FIG. 2 is a conceptual diagram for explaining the tensor factorization of the high-dimensional tensor.

The tensor factorization is a type of tensor analysis technique that may calculate a latent structure that makes up the tensor. The tensor factorization may reduce dimensions of tensor data of high-dimension and large volumes and express the tensor data by fewer number of parameters than existing data.

Explaining an example of the number of taxi operations of FIG. 1 by FIG. 2, the number of taxi operations may be represented by a three-dimensional tensor, and when factorizing each of them to a one-dimensional tensor, U⁽¹⁾ may be represented by an factor matrix that represents the direction/distance at the departure point, U⁽²⁾ may be represented by an factor matrix that represents the direction/distance at destination, and U⁽³⁾ may be represented by a factor matrix that represents the time elapsed from the departure time.

This specification is based on a factorization method that includes a temporal factor matrix in the tensor factorization method. For example, CANDECOMP/PARAFAC (CP) factorization model among the temporal factor factorization models may be used. Hereinafter, it is referred to as a CP factorization method. An N-dimensional (Rank N) tensor may be represented by an outer product of the one-dimensional (rank-1) tensor R. For example, a tensor x based on the real data may be expressed as Equation (2).

$$𝒳 \approx {\sum }_{r = 1}^{R} {\tilde{u}}_{r}^{( 1 )} ◦ {\tilde{u}}_{r}^{( 2 )} ◦ … ◦ {\tilde{u}}_{r}^{( N )} = 〚 {U}^{( 1 )} … , {U}^{( N )} 〛 \qquad ( 2 )$$

In example embodiments, U⁽ⁿ⁾=[ũ₁⁽ⁿ⁾, . . . , ũ_{R}⁽ⁿ⁾]∈ [symbol] ^{I}^{ₙ}^{×R} is a factor matrix of mode n, and a row vector may be expressed as U⁽ⁿ⁾=[u₁⁽ⁿ⁾, . . . , u_{I}_{ₙ}⁽ⁿ⁾]^{T}.

If one axis of the tensor means time, the corresponding factor matrix may be defined as the temporal factor matrix. That is, if U⁽³⁾ of the number of taxi operations is explained by Equation (2), the time factor matrix that has passed from the departure time of the taxi may be represented by U⁽³⁾=[ũ₁⁽³⁾, . . . , ũ_{R}⁽³⁾]. ^{—}u1³), , U_{R}(³)1.

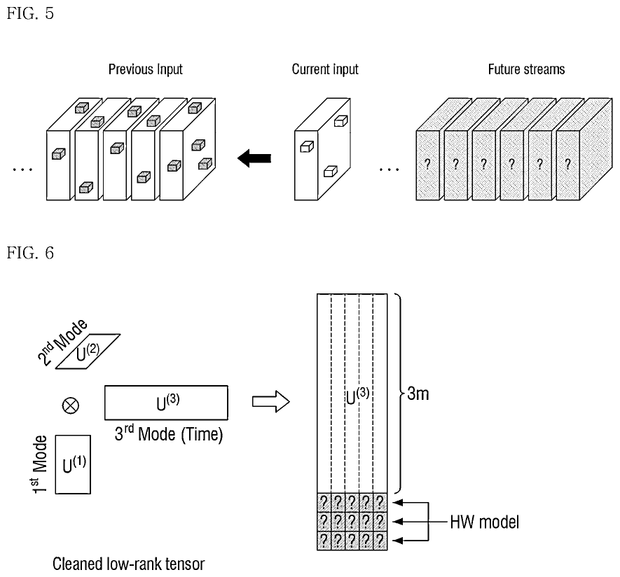

FIG. 3 is a graph for explaining the characteristics of the data pattern.

The tensor data processing method of the present inventive concepts may grasp the pattern of the observed data in the data to be input to the tensor stream, detect an outlier in the data that are input up to the present time on the basis of the grasped pattern, and estimate an estimated value corresponding to outlier and unobserved data (missing values).

In example embodiments, the data patterns may include not only the temporal characteristics of the data, but also a physical model of characteristics of the data itself, rules related to the data, a prior knowledge, and the like. The tensor data processing method of the present inventive concepts may calculate the pattern features of the tensor stream on the basis of at least two or more data patterns, detect an outlier from the observed data on the basis of the calculated pattern features, and determine estimated value corresponding to the missing value and the position of the detected outlier. Furthermore, the tensor processing method of the present inventive concepts may predict not only the tensor stream of the data observed so far but also the tensor stream of the future data to be input later on the basis of at least two or more data patterns, and detect the outliers in advance and estimate the missing values.

In some example embodiments, if there is sensing data related to the sensor, a pattern based on the hardware characteristics (sensing margin, sensor input/output characteristics, etc.) of the sensor itself may be considered together with the temporal characteristics. In other example embodiments, if there is data related to the CPU, the pattern related to the hardware characteristics and the operating characteristics of the CPU may be considered together with the temporal characteristics.

Hereinafter, although the tensor data processing method will be described focusing on the temporal characteristic pattern, the tensor data may be processed by also combining other data pattern features according to various example embodiments described above.

For example, if a temporal component is included in the data, the data to be input to the tensor stream show temporal smoothness and seasonal smoothness with the flow of time.

The temporal smoothness means that tensor data over continuous time have similar values. For example, the internal temperature, humidity, and illuminance of an office at 9:10 am are similar to the internal temperature, humidity and illuminance of the office at 9:20 am. The seasonal smoothness means that tensor data of continuous cycles have similar values. For example, the internal temperature, humidity, and illuminance of the office at 9:10 today may be similar to the internal temperature, humidity, and illuminance of the office at 9:10 am tomorrow.

Taking the example of an international visitor night event in Australia, shown in FIG. 3, the number of international visitors tends to increase gradually, while the tensor goes up and down from 2005 to 2020. In order to grasp the pattern shown on the time series with respect to the number of international visitors (input data), the tensor factorization method may be subdivided for each factor, and the pattern may be grasped. For example, it may be examined separately by level, trend, and seasonal components.

For example, a level of a left graph (e.g., an average value for that year) shows a gradual trend of increase from 30 million to 60 million, and a trend of a left graph shows a gradual decrease until 2014 compared to before 2007 when looking at the slope of the graph that fluctuates in one year. Also, the seasonality of the input tensor is shown to fluctuate at an amplitude of a predetermined or alternatively, desired interval.

When such patterns are grasped, the visitor numbers in January 2005 to January 2013 may be used to predict the visitor numbers in January 2014 on the basis of the levels, trends and seasonality mentioned above. In addition, the number of visitors on Jan. 20, 2014 may be predicted on the basis of the number of visitors on Jan. 15, 2014. If the number of visitors on Jan. 20, 2014 is out of a predetermined or alternatively, desired range from the estimated value, it may be determined as an outlier, and in some example embodiments, it may be excluded from the tensor stream. It may also be used to predict the number of international visitors on the subsequent date, for example, Jan. 25, 2014, by substituting the estimated value estimated by previous data to the data determined to be outliers.

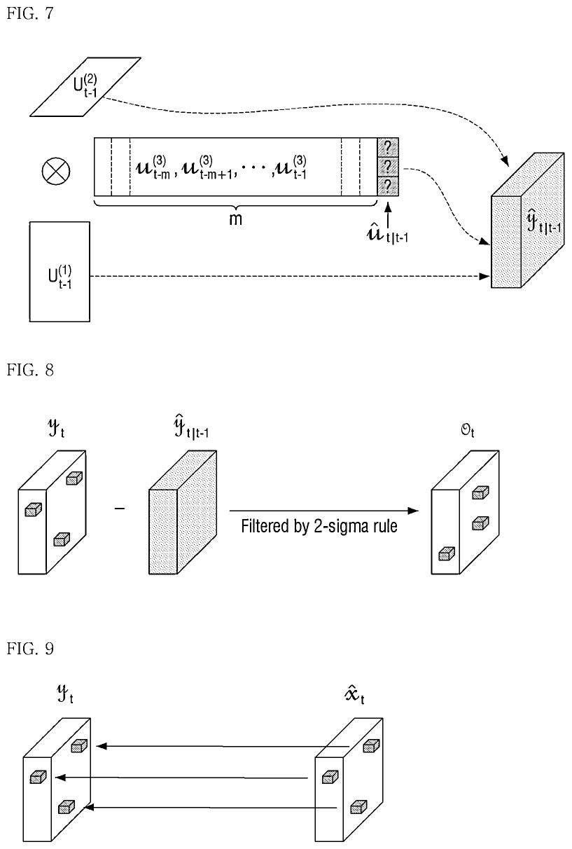

FIGS. 4 to 10 are conceptual diagrams for explaining a tensor data processing method of the present inventive concepts.

The input tensor y includes a real tensor x including data within the normal range and outlier (oᵢₙᵢₜ). Assuming an incomplete N-dimensional real tensor x and rank R, the indicator matrix Ω is a binary tensor of the same size as χ, and the value of each factor ω in the matrix means whether to observe the element χ at the corresponding position. The indicator matrix Ω is defined as in Equation (3).

$${ω}_{{i}_{1} … {i}_{N}} = \{ \begin{matrix}1 & if {x}_{{i}_{1} … {i}_{N}} is known , \\ 0 & if {x}_{{i}_{1} … {i}_{N}} is missing ,\end{matrix} \qquad ( 3 )$$

CP factorization is to find a factor matrix that reduces or minimizes the missing function of Equation (4) using only the observed tensor x. Equation (4) shows a value based on Frobenius norm (see Table 1) of hadamard product of the indicator matrix Ω, on the value obtained by subtracting the factor matrix {U^{(N)}}ₙ₌₁^{N} that reduce or minimize the missing function from the real tensor x.

$${min}_{{U}^{( 1 )} … , {U}^{( N )}} \frac{1}{2} {‖ Ω ( 𝒳 - 〚 {U}^{( 1 )} , … , {U}^{( N )} 〛 ) ‖}_{F}^{2} \qquad ( 4 )$$

That is, a factor matrix {U^{(N)}}ₙ₌₁^{N} that allows CP factorization with few missing value or outliers is found in the real data. An estimated tensor \hat{χ} may be restored by the use of the factor matrices calculated using the tensor factorization method, and the values missed from the real tensor χ may be estimated as the value \hat{χ} of the restored tensor.

The tensor data processing method according to some example embodiments includes a static tensor factorization model and a dynamic tensor factorization model. The static tensor factorization model may be based on the pattern characteristics of the data observed in a given time interval (e.g., Jan. 15, 2014, Jan. 20, 2014, and Jan. 25, 2014 in the example of FIG. 3). The dynamic tensor factorization model may be based on pattern characteristics of data observed in a given period (e.g., January 2013, January 2014, and January 2015 in the example of FIG. 3).

To detect outliers/missing values in the tensor stream, the periodic pattern and trend may be extracted from the previous tensor inputs (e.g., from 0 to t−1 time point) using the static tensor factorization model, and the data that does not match the extracted periodic pattern and the trend may be determined as an outlier. Alternatively, the missing value may be found.

Referring to FIG. 4, it is assumed that an N-dimensional static tensor y∈ [symbol] ^{I}^{₁}^{×I}^{₂}^{× . . . ×I}^{_{N}} which is observed at a given period, e.g., partially and includes outliers/missing values is received. The received input tensor y may be expressed as the sum of the real tensor χ including the normal value and the outlier tensor [symbol] (y=χ+ [symbol] ). The cost function of the tensor factorization model of the static tensor may be represented by Equation (5).

$$C ( {\{ {U}^{( N )} \}}_{n = 1}^{N} \cdot 𝒪 ) = {‖ Ω ( 𝒴 - 𝒪 - 𝒳 ) ‖}_{F}^{2} + {λ}_{1} {‖ {L}_{1} {U}^{( N )} ‖}_{F}^{2} + {λ}_{2} {‖ {L}_{m} {U}^{( N )} ‖}_{F}^{2} + {λ}_{3} {‖ 𝒪 ‖}_{1} , \qquad ( 5 )$$

$$subject to$$

$$𝒳 = 〚 {U}^{( 1 )} , … , {U}^{( N )} 〛 ,$$

$${‖ {\check{u}}_{r}^{( n )} ‖}_{2} = 1 ,$$

$${∀}_{r} ∈ \{ 1 , … , R \} ,$$

$${∀}_{n} ∈ \{ 1 , … , N - 1 \} ,$$

Referring to Equation (5), the static tensor factorization model looks for a factor matrix {U^{(N)}}ₙ₌₁^{N} and an outlier tensor [symbol] that reduce or minimize the cost function C. In the Equation (5), λ₁ and λ₂ are a temporal smoothness control parameter and a periodic smoothness control parameter, respectively, and λ₃ is a sparsity control parameter that controls sparsity of the outlier [symbol] . m is a period, and each matrix Lᵢ∈ [symbol] ^{(I}^{_{N}}^{-i)×I}^{_{N}} is a smoothness constraint matrix as in Equation (6).

For example, when λ₁ is increased, the temporal smoothness is weighted and calculated, and when λ₂ is increased, the periodic smoothness is weighted and calculated. When λ₃ is increased, the outlier is sparse with small density. In other words, as λ₁ and λ₂ are increased, the more similar value will be made in terms of time and period.

$${L}_{1} = [ \begin{matrix}1 & - 1 & & … & & & \\ & 1 & - 1 & & & & \\ & ⋮ & & ⋱ & & ⋮ & \\ & & & … & 1 & - 1 & \\ & & & & & 1 & - 1\end{matrix} ] ∈ {ℝ}^{( {f}_{N} - 1 ) \times {f}_{N}} , \qquad ( 6 )$$

$${L}_{m} = [ \begin{matrix}1 & … & - 1 & & … & & & & \\ & 1 & … & - 1 & & & & & \\ & & ⋮ & & ⋱ & & & ⋮ & \\ & & & & … & 1 & … & - 1 & \\ & & & & & & 1 & … & - 1\end{matrix} ] ∈ {ℝ}^{( {l}_{N} - m ) \times {l}_{N}}$$

The values of the smoothness constraint matrix are lₙₙ=1, lₙ₍ₙ₊ᵢ₎=−1 for all 0≤n≤I_{N}−i, and the remaining values are matrices having 0.

A first term ∥Ω [symbol] (y− [symbol] −χ)∥_{F}² of Equation (5) is the missing function of the error that occurs when the y tensor is factorized into the real tensor χ and the outlier tensor [symbol] , a second term λ₁∥L₁U^{(N)}∥_{F}² is a term that encourages the temporal smoothness on the temporal factor matrix U^{(N)}, a third term λ₂∥LₘU^{(N)}∥_{F}² is a term that encourages periodic smoothness on the temporal factor matrix U^{(N)}, and a fourth term λ₃∥ [symbol] ∥₁ is a term that encourages sparsity on the outlier tensor.

When extracting the periodic pattern and trend from previous tensor inputs (e.g., from 0 to t−1 time point) using the static tensor factorization model in FIG. 4, the tensor factorization model may determine the data that does not match the recombined tensor stream as an outlier as shown in FIG. 5 for the data that is input at the time point t. Alternatively, the missing value may be found.

For example, the tensor data processing method applies a dynamic tensor factorization model according to the extracted periodic patterns and trend to estimate future temporal factor matrix after the t time point (current), and generate future subtensors to which the estimated future temporal factor matrix is applied. The tensor data processing method compares the future subtensor at the estimated t time point with the input subtensor received at the actual t point. As a result of the comparison, a value which is out of the predetermined or alternatively, desired range is determined as an outlier, ignored and mapped to the estimated real data value, or a value that has no current record is determined as the missing value and is mapped to the estimated real data value.

The dynamic tensor factorization model is a model in which a temporal factor is reflected on the static tensor factorization model, and assumes the example of a dynamic tensor stream in which tensors are continuously collected in the form of a stream. This is the example where an incomplete subtensor yₜ∈ [symbol] ^{I}^{₁}^{×. . . ×I}^{_{N−1}} is continuously received at the time t=1, 2, . . . .

$${C}_{t} ( {\{ {U}^{( N )} \}}_{n = 1}^{N - 1} , {\{ {u}_{τ}^{( N )} , {𝒪}_{τ} \}}_{τ = 1}^{t} ) = {\sum }_{τ = 1}^{t} [ {‖ {Ω}_{τ} ( {𝒴}_{τ} - {𝒪}_{τ} - {𝒳}_{τ} ) ‖}_{F}^{2} + {λ}_{1} {‖ {P}_{τ} ‖}_{F}^{2} + {λ}_{2} {‖ {q}_{τ} ‖}_{F}^{2} + {λ}_{3} {‖ {𝒪}_{τ} ‖}_{1} ] , \qquad ( 7 )$$

$$subject to$$

$${𝒳}_{τ} = 〚 {\{ {U}^{( n )} \}}_{n = 1}^{N - 1} , {u}_{τ}^{( N )} 〛 , {‖ {\tilde{u}}_{r}^{( n )} ‖}_{2} = 1 ,$$

$${∀}_{r} ∈ \{ 1 , … , R \} , {∀}_{n} ∈ \{ 1 , … , N - 1 \} ,$$

A first term in Equation (7) is a missing function of the error that occurs when the input tensor y_{τ} is factorized into the real tensor χ_{τ} and the outlier tensor [symbol] _{τ}, a second term is a term that encourages temporal smoothness on u_{τ}^{(N)} which is a vector newly added to the temporal factor matrix U^{(N)}, a third term is a term that encourages periodic smoothness on u_{τ}^{(N)} which is a vector newly added to the temporal factor matrix U^{(N)}, and a fourth term is a term that encourages sparsity on the outlier tensor [symbol] _{τ}. In the Equation (7), λ₁ and λ₂ are the temporal smoothness control parameter and the periodic smoothness control parameter, respectively, and λ₃ a sparsity control parameter that controls the sparsity of the outlier [symbol] . p_{τ} and q_{τ} are expressed as in Equation (8), respectively.

$${p}_{τ} = \{ \begin{matrix}{u}_{τ - 1}^{( N )} - {u}_{τ}^{( N )} & if τ > 1 , \\ 0 & otherwise\end{matrix} \qquad ( 8 )$$

$${q}_{τ} = \{ \begin{matrix}{u}_{τ - m}^{( N )} - {u}_{τ}^{( N )} & if τ > m , \\ 0 & otherwise\end{matrix}$$

In Equations (7) and (8), u_{τ}^{(N)} is a temporal vector, which is a τ-th row vector of the temporal factor matrix, and means a temporal component of the input tensor y_{τ}.

That is, referring to Equations (7) and (8), the dynamic tensor factorization model also finds the factor matrix {U^{(N)}}ₙ₌₁^{N} and the outlier tensor [symbol] that reduce or minimize Equation (7) at each time t. However, the time-series concept t is added to Equation (5), and if t=I_{N}, Equations (5) and (7) become the same.

The tensor data processing method of the present inventive concepts may estimate the missing value included in the tensor stream and remove the outlier in real time. To this end, i) initialization of the tensor factorization model, ii) application to the temporal factor factorization model, and iii) dynamic update of the tensor stream are performed.

1. Initialization of Tensor Factorization Model

Referring to FIG. 4, the tensor data processing method first initializes the static tensor factorization model. The static tensor factorization model may be based on a tensor stream of short time required for initialization. For example, a length tᵢ of the tensor stream for deriving the temporal factor matrix of the static tensor factorization model may use three times (tᵢ=3 m) or more of the minimum period m. In example embodiments, the minimum period means the minimum period at which periodic smoothness may be observed. The tensor data collected for initialization initializes each of the factor matrices U⁽¹⁾, U⁽²⁾ and U⁽³⁾ and outlier tensors [symbol] of the real tensor x, using Equation (5).

According to example embodiments, the initialization of the tensor factorization model may be performed as in Algorithm 1. Algorithm 1 is to find the factor matrix {U^{(N)}}ₙ₌₁^{N} and outlier tensor [symbol] that reduce or minimize the cost function C on the basis of Equation (5).

<Algorithm 1>
Algorithm 1: Initialization

| | Input : { [symbol] ₜ, Ωₜ}ₜ₌₁^{t}^{ᵢ}, R, m, λ₁, λ₂, λ₃ | |
|---|---|---|
| | Output: (1) completed tensor \hat{χ}ᵢₙᵢₜ = {\hat{χ}ₜ}ₜ₌₁^{t}^{ᵢ}, | |
| | (2) factor matrices {U⁽ⁿ⁾}ₙ₌₁^{N} | |
| 1 | [symbol] ᵢₙᵢₜ ← [ [symbol] ₁, [symbol] ₂, . . . , [symbol] ₜ_{ᵢ}] | |
| 2 | Ωᵢₙᵢₜ ← [Ω₁, Ω₂, . . . , Ωₜ_{ᵢ}] | |
| 3 | [symbol] ᵢₙᵢₜ ← [symbol] _{I}_{₁} × . . . × I_{N-1} × tᵢ | |
| 4 | randomly initialize {U⁽ⁿ⁾}ₙ₌₁^{N} | |
| 5 | λ_{3,init} ← λ₃ | |
| 6 | repeat | |
| 7 | \| | \hat{χ}ᵢₙᵢₜ, {U⁽ⁿ⁾}ₙ₌₁^{N} ← SOFIA_{ALS} ( [symbol] ᵢₙᵢₜ, . . . , {U⁽ⁿ⁾}ₙ₌₁^{N}) |
| 8 | \| | [symbol] ᵢₙᵢₜ ← SoftThresholding(Ωᵢₙᵢₜ [symbol] ( [symbol] ᵢₙᵢₜ − \hat{χ}ᵢₙᵢₜ), λ₃) |
| 9 | \| | λ₃ ← d · λ₃ |
| 10 | \| | if λ₃ < λ_{3,init}/100 then |
| 11 | \| | └ λ₃ ← λ_{3,init}/100 |

| | |
|---|---|
| 12 | $until \frac{{‖ {\hat{𝒳}}_{pre} - {\ddot{𝒳}}_{init} ‖}_{F}}{{\hat{𝒳}}_{pre}} < tol$ |

First, each subtensor yₜ of tᵢ is connected to generate a matrix Ω and an outlier tensor oᵢₙᵢₜ of the same size as the collective tensor yᵢₙᵢₜ and the real tensor χ, and initialize the factor matrix {U^{(N)}}ₙ₌₁^{N}. The temporal components matrix is found using SOFIA_{ALS}, and outlier tensors is detected according to Equation (9) like line 8 of Algorithm 1.

SoftThresholding(x,λ₃)=sign(x)·max(|x|−λ₃, 0) (9)

Explaining Equation (9), if the value calculated as Ωᵢₙᵢₜ [symbol] (yᵢₙᵢₜ−\hat{x}ᵢₙᵢₜ) exceeds λ₃, this example is determined as the outlier tensor oᵢₙᵢₜ and the value is mapped to 0 instead of the outlier data.

In order to increase the speed of detecting outliers according to example embodiments, the value λ₃ may be detected using a decade factor d like algorithms line 9 to line 12 of Algorithm 1, and the outliers may be detected, while gradually reducing the value λ₃. For example, the decade factor d is about 0.8 to reduce the scale of the value λ₃.

On the other hand, like Line 7 of Algorithm 1, optimization may be performed in an ALS (Alternating Least Squares) manner to estimate the factor matrix from the input tensor yᵢₙᵢₜ at the time of tensor factorization. The ALS manner is to fix other matrix (for example, second factor matrix) except the first factor matrix to update one matrix (for example, the first factor matrix), and then update the first factor matrix in the direction of optimizing Equation (5). As an example, the initialization of the tensor factorization model may obtain outliers and temporal factor, using SOFIA_{ALS} like Algorithm 2.

<Algorithm 2>
Algorithm 2: SOFIA_{ALS}: Batch Update in SOFIA

| | |
|---|---|
| Input : | (1) [symbol] , [symbol] , Ω, R, m, λ₁, λ₂, |
| | (2) initial factor matrices {U⁽ⁿ⁾}ₙ₌₁^{N} |
| Output: | (l) completed tensor \acute{X}, |
| | (2) upated factor matrices {U⁽ⁿ⁾}ₙ₌₁^{N} |

| 1 | [symbol] ^{*} = [symbol] − [symbol] | | | |
|---|---|---|---|---|
| 2 | repeat | | | |
| 3 | \| | for n = 1, . . . , N − 1 do | | |
| 4 | \| | \| | for iₙ = 1, . . . , Iₙ do | |
| 5 | \| | \| | \| | Calculate Bᵢ_{ₙ}⁽ⁿ⁾ and cᵢ_{ₙ}⁽ⁿ⁾ using (14) and (15) |
| 6 | \| | \| | └ | Update uᵢ_{ₙ}⁽ⁿ⁾ using (13) |
| 7 | \| | \| | for r = 1, . . . , R do | |
| 8 | \| | \| | \| | ũᵣ^{(N)} ← ũᵣ^{(N)} · \|\|ũᵣ⁽ⁿ⁾\|\|₂ |
| 9 | \| | \| | └ | ũᵣ⁽ⁿ⁾ ← ũᵣ⁽ⁿ⁾/\|\|ũᵣ⁽ⁿ⁾\|\|₂ |
| | \| | └ | | |

| 10 | \| | for i_{N} = 1, . . . , I_{N} do | |
|---|---|---|---|
| 11 | \| | \| | Calculate Bᵢ_{_{N}}^{(N)} and cᵢ_{_{N}}^{(N)} using (14) and (15) |
| 12 | \| | └ | Update uᵢ_{_{N}}^{(N)} using (17) |

| | | |
|---|---|---|
| 13 | \| | \hat{χ} ← [[U⁽¹⁾, . . . , U^{(N)}]] |
| 14 | \| \| | $fitness ← 1 - \frac{‖ Ω ( {y}^{*} - χ ) {‖}_{F}}{‖ Ω {y}^{*} {‖}_{F}}$ |

| | |
|---|---|
| 15 | until Δfitness < tol |

Referring to Algorithm 2, SOFIA_{ALS} updates the non-temporal factor matrix U⁽ⁿ⁾ row by row in the input tensor y*=yᵢₙᵢₜ− [symbol] ᵢₙᵢₜ in which the outlier is removed, using Equation (10).

For example, referring to line 3 to line 9 of Algorithm 2, a single non-temporal factor matrix uᵢ_{ₙ}⁽ⁿ⁾ that reduces or minimizes the cost function C({U⁽ⁿ⁾}ₙ₌₁^{N}, [symbol] ) of Equation (10) is found, using Equations (11) and (12) from the non-temporal factor matrix.

$$\text{?} \qquad ( 10 )$$

$$\text{?} \qquad ( 11 )$$

$$\text{?} \qquad ( 12 )$$

$$\text{?} \text{indicates text missing or illegible when filed}$$

In order to find the value that reduces or minimizes the cost function C({U⁽ⁿ⁾}ₙ₌₁^{N}, [symbol] ), it is possible to calculate uᵢ_{ₙ}⁽ⁿ⁾ in which a differential value is set as 0 for each index iₙ according to Equation (13) in the input tensor stream. In example embodiments, iₙ and j have a range of 1≤iₙ≤Iₙ, and 1≤j≤R.

$$\frac{\partial C}{\partial {u}_{{i}_{n} j}^{( n )}} = {\sum }_{( {i}_{1} , … , {i}_{N} ) ∈ {Ω}_{{i}_{n}}^{( n )}} 2 ( ( {\sum }_{r = 1}^{R} {\prod }_{l = 1}^{N} {u}_{{i}_{l} r}^{( l )} - {y}_{{i}_{1} , … , {i}_{N}}^{*} ) {\prod }_{l \neq n} {u}_{{i}_{l} j}^{( l )} ) = 0 \qquad ( 13 )$$

Equation (13) may be arranged as Equation (14),

$${{\sum }_{( {i}_{1} , … , {i}_{N} )}}_{∈ {Ω}_{{i}_{n}}^{( n )}} ( {\sum }_{r = 1}^{R} ( {u}_{{i}_{n} r}^{( n )} {\prod }_{l \neq n} {u}_{{i}_{l} r}^{( l )} ) {\prod }_{l \neq n} {u}_{{i}_{l} j}^{( l )} ) = \qquad ( 14 )$$

$${{\sum }_{( {i}_{1} , … , {i}_{N} )}}_{∈ {Ω}_{{i}_{n}}^{( n )}} ( {y}_{{i}_{1} , … , {i}_{N}}^{*} {\prod }_{l \neq n} {u}_{{i}_{l} j}^{( l )} ) , ∀ j$$

The non-temporal factor matrix uᵢ_{ₙ}⁽ⁿ⁾ is derived as in Equation (15) from Equation (14).

Bᵢ_{ₙ}⁽ⁿ⁾uᵢ_{ₙ}⁽ⁿ⁾=cᵢ_{ₙ}⁽ⁿ⁾⇔uᵢ_{ₙ}⁽ⁿ⁾=Bᵢ_{ₙ}⁽ⁿ⁾^{^{−1}}cᵢ_{ₙ}⁽ⁿ⁾ (15)

On the other hand, referring to line 10 to line 12 of Algorithm 2, each row uᵢ_{ₙ}⁽ⁿ⁾ of the temporal factor matrix U^{(N)} may find a value that reduces or minimizes the cost function C({U⁽ⁿ⁾}ₙ₌₁^{N}, [symbol] ) according to Equation (16).

$$\frac{\partial C}{\partial {u}_{{i}_{N} j}^{( N )}} = {\sum }_{( {i}_{1} , … , {i}_{N} ) ∈ {Ω}_{{i}_{N}}^{( N )}} 2 ( ( {\sum }_{r = 1}^{R} {\prod }_{l = 1}^{N} {u}_{{i}_{l} r}^{( l )} - {y}_{{i}_{1} , … , {i}_{N}}^{*} ) {\prod }_{l \neq n} {u}_{{i}_{l} j}^{( l )} ) + 2 {K}_{{i}_{N} j} + 2 {H}_{{i}_{N} j} = 0 , \qquad ( 16 )$$

In example embodiments, each row of the temporal factor matrix is based on Equation (17), and K_{iNj} and H_{iNj} of Equation (16) are based on Equation (18).

$${u}_{{i}_{N}}^{( N )} = \{ \begin{matrix}{( {B}_{{i}_{N}}^{( N )} + ( {λ}_{1} + {λ}_{2} ) {I}_{R} )}^{- 1} ( {c}_{{i}_{N}}^{( N )} + {λ}_{1} {u}_{{i}_{N} + 1}^{( N )} + {λ}_{2} {u}_{{i}_{N} + m}^{( N )} ) & if {i}_{N} = 1 \\ {( {B}_{{i}_{N}}^{( N )} + ( 2 {λ}_{1} + {λ}_{2} ) {I}_{R} )}^{- 1} ( {c}_{{i}_{N}}^{( N )} + {λ}_{2} ( {u}_{{i}_{N} + 1}^{( N )} + {u}_{{i}_{N} + 1}^{( N )} ) + {λ}_{2} {u}_{{i}_{N} + m}^{( N )} ) & else if 1 < {i}_{N} \leq m , \\ {( {B}_{{i}_{N}}^{( N )} + 2 ( {λ}_{1} + {λ}_{2} ) {I}_{R} )}^{- 1} ( {c}_{{i}_{N}}^{( N )} + {λ}_{3} ( {u}_{{i}_{N} + 1}^{( N )} + {u}_{{i}_{N} + 1}^{( N )} ) + {λ}_{3} ( {u}_{{i}_{N} - m}^{( N )} + {u}_{{i}_{N} + m}^{( N )} ) ) & else if m < {i}_{N} \leq {I}_{N} - m , \\ {( {B}_{{i}_{N}}^{( N )} + ( 2 {λ}_{1} + {λ}_{2} ) {I}_{R} )}^{- 1} ( {c}_{{i}_{N}}^{( N )} + {λ}_{1} ( {u}_{{i}_{N} + 1}^{( N )} + {u}_{{i}_{N} + 1}^{( N )} ) + {λ}_{2} {u}_{{i}_{N} - m}^{( N )} ) & else if {I}_{N} - m < {i}_{N} \leq {I}_{N} - 1 , \\ {( {B}_{{i}_{N}}^{( N )} + ( {λ}_{1} + {λ}_{2} ) {I}_{R} )}^{- 1} ( {c}_{{i}_{N}}^{( N )} + {λ}_{1} {u}_{{i}_{N} + 1}^{( N )} + {λ}_{2} {u}_{{i}_{N} - m}^{( N )} ) & otherwise .\end{matrix} \qquad ( 17 )$$

In summary, the initialization method calculates a temporal factor matrix U^{(N)}, using the static tensor factorization model of Equation (5) and the ALS manner from a tensor stream which is input multiple times (for example, three times) the minimum period.

2. Application to Temporal Factor Factorization Model

As a result of initialization, a temporal factor matrix U^{(N)} having each of row ũ₁^{(N)}, ũ₂^{(N)}, . . . , ũ_{R}^{(N)}, which has a length tᵢ and a period m is calculated.

The temporal factor factorization model may extract a predetermined or alternatively, desired pattern from the temporal factor matrix. For example, when applying the temporal factor matrix to the temporal factor factorization model, the level, trend, and seasonality patterns of the temporal factor matrix U^{(N)}. For example, it is possible to extract that the number of international visitors to Australia as explained in FIG. 3 has a pattern in which the level extracted by the HW method from the left graph steadily increases from before 2007 to after 2016, a pattern in which the trend extracted from the left graph (that is, the increasing and decreasing slope) gradually decreases and then increases again from 2007 to 2015, and a pattern in which the seasonality extracted from the left graph increases and decreases at regular intervals but an amplitude of increase and decrease gradually increases.

Halt-Winters model (hereinafter referred to as a HW model) may be used as the temporal factor factorization model according to some example embodiments. The HW model may be defined by one prediction equation such as Equation (24) based on three smoothness equations such as Equations (21) to (23) below.

lₜ=α(yₜ−sₜ₋ₘ)+(1−α)(lₜ₋₁+bₜ₋₁), (21)

bₜ=β(lₜ−lₜ₋₁)+(1−β)bₜ₋₁, (22)

sₜ=γ(yₜ−lₜ₋₁−bₜ₋₁)+(1−γ)sₜ₋ₘ (23)

Equation (21) shows an equation for a level pattern on the time t of the temporal factor factorization model, Equation (22) shows an equation for a trend pattern on the time t of the temporal factor factorization model, and Equation (23) shows an equation of the seasonality pattern on the time t of the temporal factor factorization model. In example embodiments, each of the coefficients α, β, γ is a real number between 0 and 1.

$$\hat{y} t + h \vert t = {l}_{t} + {hb}_{t} + {s}_{t + h - m ( ⌊ \frac{h - 1}{m} ⌋ + 1 )} \qquad ( 24 )$$

In Equation (24), ŷ_{t+h|t} is a predicted temporal factor matrix after the lapse of h at the time t, and m means a seasonality period.

$$⌊ \frac{h - 1}{m} ⌋ + 1$$

allows estimated value of the seasonal component used in the estimation to be calculated in the last season of the time series. The HW model exponentially decreases the weight as the generated time point of data is old, and increases the weight as the generated time point is recent. In order to access with this weighted average manner, it is necessary to estimate the smoothing parameters and initial values of level, trend, and seasonal components.

When the time t is t=1, . . . , T in the collected tensor stream, T means the last time point, and a difference between the t time point and the previous t−1 time point is derived like eₜ=yₜ−\tilde{y}_{t|t-1} in the HW model. In example embodiments, the initial values and coefficients α, β, γ of the level, trend, and seasonal components are found using the sum of squared errors (SSE) Σₜ₌₁^{T}e₁² so that the SSE is reduced or minimized to find a difference eₜ.

That is, learning of the HW model is to find a level pattern or a trend pattern or a seasonality pattern in which the difference SSE between the previous time point t−1 and the current time point t is reduced or minimized, while controlling the coefficients α, β, γ.

A specific description of the HW model refers to C C Holt, “Forecasting seasonals and trends by exponentially weighted moving averages,” International journal of forecasting, vol. 20, no. 1, pp. 5-10, 2004, and P R Winters, “Forecasting sales by exponentially weighted moving averages, Management science, vol. 6, no. 3, pp. 324-342, 1960.

In this specification, although the HW model has been described as an example, an ARIMA model and a Seasonal ARIMA model may be used as the temporal factor factorization model according to various example embodiments, and a temporal prediction algorithm based on machine learning may also be applied.

3. Dynamic Update of Tensor Stream

Referring to FIG. 5, the dynamic update continuously removes outliers [symbol] ₜ from the subtensors yₜ (previous input) continuously received to restore each factor matrix, that is, the real tensor χₜ. The restored factor matrix includes level, trend, and seasonal component in the example of the data pattern characteristics, for example, temporal characteristics. For example, the restored factor matrix may be restored, using the level pattern, trend pattern, or seasonality pattern calculated in the previous process.

The restored factor matrix is used to estimate the missing value on the basis of the difference from the newly received subtensor (current input). Algorithm 3 relates to a dynamic update in the tensor data processing method.

Algorithm 3: Dynamic Updates in SOFIA

| | Input | | : (1) { [symbol] ₜ, Ωₜ}ₜ₌ₜ_{ᵢ}₊₁^{∞}, R, m, λ₁, λ₂, λ₃, μ, ϕ, |
|---|---|---|---|
| | | | (2) {Uₜ_{ᵢ}⁽ⁿ⁾}ₙ₌₁^{N-1}, {uₜ^{(N)}}ₜ₌ₜ_{ᵢ}₋ₘ₊₁^{t}^{ᵢ}, |
| | | | (3) HW factors lₜ_{ᵢ}, bₜ_{ᵢ}, {sₜ}ₜ₌ₜ_{ᵢ}₋ₘ₊₁^{t}^{ᵢ}, α, β, γ |
| 1 | \hat{Σ}ₜ_{ᵢ} ← λ₃/100 × 1_{I}_{₁}_{×...×I}_{_{N−1}} | | |
| 2 | for t = tᵢ + 1, tᵢ + 2, . . . do | | |
| 3 | \| | û_{t\|t-1}^{(N)} ← lₜ₋₁ + bₜ₋₁ + sₜ₋ₘ | |
| 4 | \| | ${\hat{𝒴}}_{t \vert t - 1} ← 〚 {\{ {U}_{t - 1}^{( n )} \}}_{n = 1}^{N - 1} ; {\hat{u}}_{t \vert t - 1}^{( N )} 〛$ | |
| 5 | \| | Estimate [symbol] ₜ with (21) | |
| 6 | \| | Update \hat{Σ}ₜ with (22) | |
| 7 | \| | for n = 1, . . . , N − 1 do | |
| 8 | \| | \|_ | Update Uₜ⁽ⁿ⁾ using (24) |

| | | |
|---|---|---|
| 9 | \| | Update uₜ^{(N)} using (25) |
| 10 | \| | Update lₜ, bₜ, sₜ using (26) |
| 11 | \|_ | ${\hat{𝒳}}_{t} ← 〚 {\{ {U}_{t}^{( n )} \}}_{n = 1}^{N - 1} , {u}_{t}^{( N )} 〛$ |

1) Estimation of Outlier Subtensor [symbol] ₜ at time t

Referring to line 3 of Algorithm 3, and FIGS. 5 to 8, the t-th vector may be predicted using the temporal prediction algorithm, assuming that each column of the factor matrix U^{(N)} is a time series with a length of t−1 and a period of m. For example, the t-th vector may be obtained as shown in Equation (25), using level (l), trend (t), and seasonality (s) patterns of U^{(N)} calculated by being applied to the HW model as in FIG. 7.)

û_{t|t-1}^{(N)}=lₜ₋₁+bₜ₋₁+sₜ₋ₘ (25)

That is, as in line 4 of Algorithm 3, the prediction subtensor ŷ_{t|t-1} may be calculated as in Equation (26) on the basis of Equation (25) for the temporal factor matrix.

ŷ_{t|t-1}= [symbol] {Uₜ₋₁⁽ⁿ⁾}ₙ₌₁^{N-1}, û_{t|t-1}^{(N)} [symbol] (26)

As in FIG. 8, the tensor data processing method of the present inventive concepts determines an outlier when a difference between the actually input subtensor yₜ and the predicted subtensor ŷ_{t|t-1} of Equation (26) is abnormally large. For example, outlier detection may use a 2-sigma rule. The 2-sigma rule means that about 95% values of the total data in a normal distribution exist in the range of 2 standard deviations on both sides on average. The tensor data processing method of the present inventive concepts determines an outlier, when the values do not belong to the range of 2 standard deviations on the basis of the 2-sigma rule. Referring to line 5 of Algorithm 3, Equation (27) estimates the outlier subtensor [symbol] ₜ using the 2-sigma rule.

$$\begin{matrix}{𝒴}_{i}^{*} = Ψ ( \frac{{𝒴}_{i} - {\hat{𝒴}}_{t \vert t - 1}}{{\hat{\sum }}_{t - 1}} ) {\hat{\sum }}_{t - 1} + {\hat{𝒴}}_{t \vert t - 1} \\ = {𝒴}_{t} - {𝒪}_{t} , \\ ⇔ {𝒪}_{t} = {𝒴}_{t} - {\hat{𝒴}}_{t \vert l - 1} - Ψ ( \frac{{𝒴}_{t} - {\hat{𝒴}}_{t \vert t - 1}}{{\hat{\sum }}_{t - 1}} ) {\hat{\sum }}_{t - 1} ,\end{matrix} \qquad ( 27 )$$

In Equation (27), \hat{Σ}ₜ₋₁ is an error scale tensor, which is a tensor that stores how many errors occur in each entry. The 2-sigma rule is represented as in Equation (28).

$$Ψ ( \cdot ) = \{ \begin{matrix}x , & if \vert x \vert < 2 \\ 2 \cdot sign ( x ) , & otherwise\end{matrix} \qquad ( 28 )$$

According to the procedure described above, the outlier tensor [symbol] ₜ of the currently input subtensor (FIG. 5, current input) may be detected in real time.

2) Update of Non-Temporal Factor Matrix

When the outlier tensor [symbol] ₜ detected by Equation (27) is subtracted from the actually input subtensor yₜ, the time t, that is, the real tensor xₜ of the currently input tensor, is calculated. Ideally, there is a need to update the non-temporal factor matrix U⁽ⁿ⁾ to reduce or minimize Equation (7) which is the cost function for all subtensors yᵢₙᵢₜ received before the time t. However, since the length of the tensor stream may increase to infinity, a new cost function fₜ that considers only the item of the time t is defined by Equation (29).

$$\begin{matrix}{f}_{t} ( {\{ {U}^{( n )} \}}_{n = 1}^{N - 1} , {u}^{( N )} ) = {‖ {Ω}_{t} ( {𝒴}_{t} - {𝒪}_{t} - 〚 {\{ {U}^{( n )} \}}_{n = 1}^{N - 1 ,} , {u}^{( N )} 〛 ) ‖}_{F}^{2} + \\ {{λ}_{1} {‖ {u}_{t - 1}^{( N )} - {u}^{( N )} ‖}_{F}^{2} + {λ}_{2} {‖ {u}_{t - {n}_{t}}^{( N )} - {u}^{( N )} ‖}_{F}^{2} + {λ}_{3} ‖ {𝒪}_{t} ‖}^{1}\end{matrix} \qquad ( 29 )$$

That is, when comparing Equation (7) with Equation (29), Equation (7) calculates the cost function on the basis of the subtensor yₜ to be input at the time t=1, 2, . . . , but Equation (29) is calculated in consideration of only an example where the subtensor yₜ is related to the time t.

The non-temporal factor matrix _{{U}⁽ⁿ⁾}ₙ₌₁^{N-1} may be calculated by applying Equation (29) to the gradient descent algorithm (gradient descent, or gradient descent method).

A residual subtensor of Ωᵢ [symbol] (yₜ− [symbol] ₜ− [symbol] {U⁽ⁿ⁾}ₙ₌₁^{N-1}, u^{(N)} [symbol] ) is set as Rₜ in Equation (29). The non-temporal factor matrix needs to be updated in the direction of reducing or minimizing Equation (29) in units of size μ (that is, reducing or minimizing based on the derivative value of ft) as in Equation (30).

$$\begin{matrix}{U}_{t}^{( n )} = {U}_{t - 1}^{( n )} - μ \frac{\partial {f}_{t} ( {\{ {U}_{t - 1}^{( n )} \}}_{n = 1}^{N - 1} , {\hat{u}}_{t \vert t - 1}^{( N )} )}{\partial {u}^{( n )}} \\ = {U}_{t - 1}^{( n )} + 2 μ {R}_{( u )} {{⊙}_{l = 1 , 1 \neq n}}^{N - 1} {U}_{t - 1}^{( l )} \cdot diag ( {\hat{u}}_{t \vert t - 1}^{( N )} )\end{matrix} \qquad ( 30 )$$

In example embodiments, R₍ₙ₎ is represented by a matrix of the mode n of the subtensor Rₜ (mode-n matricization of Rt).

That is, the non-temporal factor matrix Uₜ₋₁⁽ⁿ⁾ up to now may be updated to the non-temporal factor matrix Uₜ⁽ⁿ⁾ of the next time t according to Equation (30).

3) Update of Temporal Factor Matrix

Temporal factor matrix uₜ^{(N)} is also needed to be updated in the direction of reducing or minimizing Equation (29) in units of size μ (that is, reducing or minimizing based on the differential value of ft) as in Equation (31).

$$\begin{matrix}{u}_{t}^{( N )} = {\hat{u}}_{t \vert t - 1}^{( N )} - μ \frac{\partial {f}_{t} ( {\{ {U}_{t - 1}^{( n )} \}}_{n = 1}^{N - 1} , {\hat{u}}_{t \vert t - 1}^{( N )} )}{\partial {u}^{( N )}} \\ = {\hat{u}}_{t \vert t - 1}^{( N )} + 2 μ [ {( {{⊙}_{n = 1}}^{N - 1} {U}_{t - 1}^{( n )} )}^{⊤} \cdot vec ( {ℛ}_{i} ) + {λ}_{1} {u}_{t - 1}^{( N )} + {λ}_{2} {u}_{t - m}^{( N )} - ( {λ}_{1} + {λ}_{2} ) {\hat{u}}_{t \vert t - 1}^{( N )} ) ]\end{matrix} \qquad ( 31 )$$

In Equation (31), vec ( ) is a vectorization operator.

4) Update of Data Pattern Characteristics

As in line 7 to line 9 of Algorithm 3, when the non-temporal factor matrix Uₜ⁽ⁿ⁾ and the temporal factor matrix uₜ^{(N)} in terms of time t are calculated in operations 2) and 3), data pattern characteristics, that is, level patterns, trend patterns and seasonality patterns are updated for use in predicting the subtensor at the subsequent time t+1. Equation (32) calculates a level pattern lₜ, a trend pattern bₜ and a seasonality pattern sₜ which are newly updated (line 10 of Algorithm 3).

lₜ=diag(α)(uₜ^{(N)}−sₜ₋ₘ)+(I_{R}−diag(α))(lₜ₋₁+bₜ₋₁),

bₜ=diag(β)(lₜ−lₜ₋₁)+(I_{R}−diag(β))bₜ₋₁,

sₜ=diag(γ)(uₜ^{(N)}−lₜ₋₁−bₜ₋₁)+(I_{R}−diag(γ))(sₜ₋ₘ (32)

In Equation (32), diag ( ) is an operator that creates a matrix having elements of the input vector on the main diagonal. I_{R} is an R×R matrix.

5) Restoration of Real Tensor \hat{χ}ₜ

The real subtensor \hat{χ}ₜ at the time t is restored as in Equation (33), on the basis of each of the factor matrices updated as in operations 1) to 4) described above, for example, the non-temporal factor matrix Uₜ⁽ⁿ⁾ and the temporal factor matrix uₜ^{(N)}.

\hat{χ}ₜ= [symbol] {Uₜ⁽ⁿ⁾}ₙ₌₁^{N-1}, uₜ^{(N)} [symbol] (33)

Also, the restored values of the restored subtensor \hat{χ}ₜ may be used to restore the missing values. As in FIG. 9, the missing values may be restored, using the value of the restored subtensor \hat{χ}ₜ corresponding to the position of the subtensor lost in the input tensor yₜ as the estimated value.

4. Prediction of Future Subtensor

When using the tensor data processing method described above, it is possible to estimate/predict the tensor to be input later, that is, the future subtensor as in FIG. 10. If a last point of the received input tensor stream is defined as t_{end}, it is possible to predict the tensor to be received after the time h, t=t_{end}+h time. The temporal factor matrix of the time t may be calculated, by considering the time factor matrix as a time series, and by utilizing the temporal factor factorization model.

For example, the temporal factor matrix û_{t|t}_{_{end}}^{(N)} may be calculated, by applying to Equation (24) on the basis of the level pattern, trend pattern and seasonality pattern according to the Holt-Winters method described above. Further, the future subtensor ŷ_{t|t}_{_{end}} to be received at the time t may be predicted by Equation (34).

ŷ_{t|t}_{_{end}}= [symbol] {Uₜ_{_{end}}⁽ⁿ⁾}ₙ₌₁^{N-1}, û_{t|t}_{_{end}}^{(N)} [symbol] (34)

The tensor data processing method of the present inventive concepts may estimate the future subtensor ŷ_{t|t}_{_{end}} on the basis of the input tensor to be input in real time, compares it with the real input subtensor according to the estimated future subtensor ŷ_{t|t}_{_{end}}, detect and exclude the outliers, and recover the missing values.

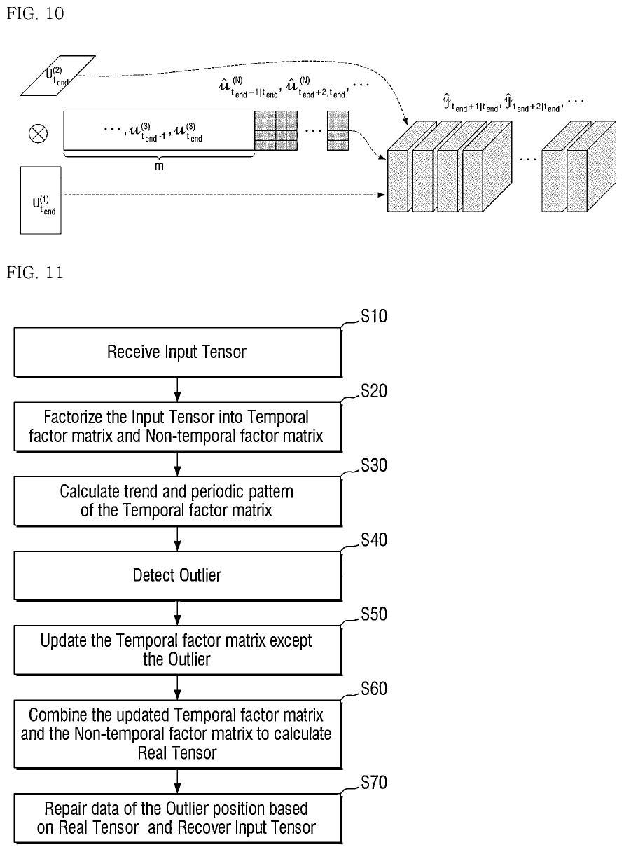

FIG. 11 is a flowchart for explaining tensor data processing method.

Referring to FIG. 11, an apparatus of performing the tensor data processing method receives a raw input tensor (S10). The raw input tensor includes at least one outliers or missing value of data. The apparatus perform factorization. Tensor factorization is an operation to divide high-dimensioned tensor data into low-rank dimensioned tensor data. For example, the apparatus factorizes the raw input tensor into temporal matrix and non-temporal factor matrix (S20).

The apparatus calculates trend and periodic pattern of the temporal factor matrix (S30). The apparatus detects an outlier from the raw input tensor data based on the trend and the periodic patterns (S40). The apparatus updates the temporal factor matrix except the outlier (S50). The apparatus combines the updated temporal factor matrix and the non-temporal factor matrix to calculate a real tensor (S60). The apparatus repair data of the outlier position based on the real tensor and recover (S70). For example, the apparatus estimates normal value of the outlier position or the missing values' position based on the trend and the periodic pattern.

Additionally, the apparatus may predict a future(next) input tensor and use it to detect new outlier based on the trend and periodic pattern of the real tensor.

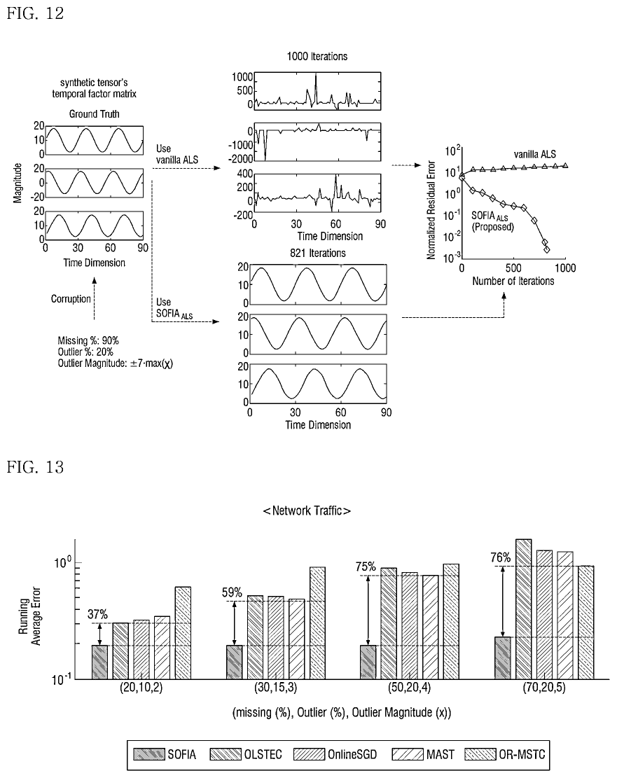

FIGS. 12 to 14 show the simulation results of the tensor data processing method of the present inventive concepts.

Referring to FIG. 12, an experiment was conducted whether it is possible to effectively remove outliers and extract temporal patterns and trends in the initialization process in order to verify the effect of the tensor data processing method of the present inventive concepts. An experiment was conducted to determine how initialization using the general ALS method (vanilla ALS) and initialization using an ALS method (SOFIA_{ASL}) using temporal and periodic smoothness well recover the existing periodic pattern.

As an input, the 90% data was lost in a 30×30×90 size synthetic tensor with a period of 30, and outliers corresponding to 7 times the largest value of the entire data values were injected into 20% data of the remaining data.

As the number of repetitions increased, the normalized resolution error was significantly lowered when using the tensor data processing method of the present inventive concepts, whereas when the general ALS, the resolution error was not lowered.

For example, as the experimental results obtained by repeating 1,000 times, when using the general ALS, although it was failed to find a periodic pattern, when using the tensor data processing method of the present inventive concepts, it was verified that the temporal characteristics, that is, the periodic patterns, may be already accurately found before reaching the 1,000th repetition even in the data in which data of 90% was lost and serious outliers were included.

Referring to FIG. 13, when using the tensor restoration method (SOFIA_{ALS}) of the present inventive concepts and other tensor data processing methods that may solve similar problems for each data set, the operating speeds are compared. Portions expressed by (X, Y and Z) in FIG. 13 mean an example where X % data of the data were lost and Y % data were contaminated with outlier having a size of Z times the maximum value of the tensor data. For example, in the case of a tensor stream of network traffic data, when restoring the missing value by the use of various tensor data processing methods, the error was lowered up to 76%, and although it was not shown, the processing speed was up to 935 times faster than other algorithms.

Referring to FIG. 14, the tensor data processing method of the present inventive concepts linearly increases the overall operating time as the number of input tensors increases. In other words, it is suitable for real-time processing for detecting the outliers and recovering the missing values in the input tensor stream.

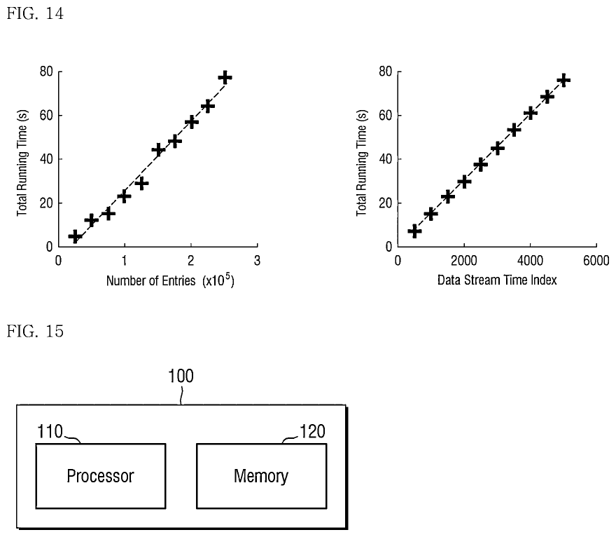

FIG. 15 is an embodiment of an electronic apparatus of the present inventive concepts.

Referring to FIG. 15, the tensor data processing method of the present inventive concepts may be performed by an electronic apparatus (100) including a processor (110) having a high operating speed and a memory (120) for processing data.

The electronic apparatus (100) may be designed to perform various functions in the semiconductor system, and the electronic apparatus (100) may include, for example, an application processor. For example, the electronic apparatus (100) may analyze the data input to the tensor stream according to the above-mentioned data processing method, extract valid information, and make a situation determination on the basis of the extracted information or control the configurations of an electronic device on which the electronic apparatus is mounted. In example embodiments, the electronic apparatus (100) may be applicable to one of a robotic device such as a drone and an advanced drivers assistance system (ADAS), and computing devices that perform various computing functions, such as a smart TV, a smart phone, a medical device, a mobile device, a video display device, a measurement device, an IoT (Internet of Things) device, an automobile, a server, and equipment. In addition, the electronic apparatus may be mounted on at least one of various types of electronic devices.

The processor (110) is, for example, an NPU (Neural Processing Unit) that performs the above-mentioned data processing method based on the input tensor data, generates an information signal based on the execution result, or may be retrained to predict the future tensor data. The processor (110) may include programmable logic according to some example embodiments, or may further include a MAC (Multiply Accumulate circuit).

Alternatively, the processor (110) may be one of various types of processing units such as a CPU (Central Processing Unit), a GPU (Graphic Processing Unit), and an MCU (Micro COntroller Unit), depending on some example embodiments.

The memory (120) may store the tensor stream to be input and the intermediate result accompanying the operation of the processor (110). For example, the memory (120) may store the raw input tensors which input to the electronic apparatus (100), real tensors and intermediate values such as temporal factor matrix or non-temporal factor matrix. The memory (120) may include a cache, a ROM (Read Only Memory), a PROM (Programmable Read Only Memory), an EPROM (Erasable PROM), an EEPROM (Electrically Erasable Programmable Read-Only Memory), a PRAM (Phase-change RAM), a Flash memory, an SRAM (Static RAM), or a DRAM (Dynamic RAM), as an operating memory, according to some example embodiments. Alternatively, the memory (120) may include a flash memory, or a resistive type such as an ReRAM (resistive RAM), a PRAM (phase change RAM), and a MRAM (magnetic RAM), as a non-volatile memory device, according to some example embodiments. In addition, the non-volatile memory device may include an integrated circuit including a processor and a RAM, for example, a storage device or a PIM (Processing in Memory).

On the other hand, the electronic apparatus may include at least one functional circuits, receive the information signal of the processor (110), determine the situation or execute other operations.

According to the tensor data processing method of the present inventive concepts described above, real-time processing is enabled in detecting the outliers and recovering the missing values. According to example embodiments, the tensor data processing method of the present inventive concepts may be utilized in a pretreatment processing that utilizes data of the temporal characteristics that appear in semiconductor facility, semiconductor design, device characteristic measurement, and the like, while reducing or minimizing the loss of information. It is also possible to process data lost in the pretreatment process or noise. Further, according to the tensor data processing method of the present inventive concepts, it may be utilized for online learning that may process data updated in real time at high speed.

Alternatively, according to the tensor data processing method of the present inventive concepts described above, it may be used to grasp the relevance of various sensor data collected from a plurality of sensors in the semiconductor process facility, detect the outlier of the sensor data or restore the missing values in real time to predict more accurately future data. Further, it is possible to detect the outlier instantly on the basis of the predicted data.

For some embodiments, the environment inside the semiconductor fabrication is very strictly managed. If a sudden change in temperature or humidity of the internal environment of the semiconductor fabrication occurs, the probability of occurrence of abnormalities in the semiconductor process increases and adversely affects the yield. Therefore, it is necessary to determine the linear correlation of sensor data collected from various types of sensors inside the semiconductor fabrication and at the same time to detect missing values and outliers in real time. It can help improve semiconductor yield by re-inspecting the semiconductor process by detecting the occurrence of outliers in real time.

Alternatively, according to the tensor data processing method of the present inventive concepts described above, in network traffic management, temporal data of traffic incoming for each server port can be efficiently managed. For example, the trend and periodicity of traffic data can be grasped, and the acceptance degree of the server can be determined through the future traffic data prediction.

For some embodiments, a network traffic management is a very important issue for companies or operators that provide internet services. For example, OTT service providers use a function that auto-scaling the number of servers according to the number of users watching the video. This present disclosure provides analyzing user's network traffic changing in real time, predicting the future, and detecting outliers. This is essential for service providers to operate non-stop and low latency.

This is because, according to the tensor data processing method of the present disclosure, network load balancing can be performed by predicting a time period when the number of viewers increases and securing more available servers in advance.

For examples, Cloud service providers such as Amazon Web Services (AWS), Google Cloud Platform (GCP), and Microsoft Azure provide the flexibility to quickly scale up or down services, such as the auto-scaling function. The auto scaling function can perform to monitor various network resources such as CPU, Memory, Disk, and Network and automatically adjust the size of the server. The cloud service providers use the technology of the present invention to analyze the resource usage of instances, to model it as a tensor, and to predict a future resource usage before it increases. This makes it possible to provide more stable cloud services.

Alternatively, according to the tensor data processing method of the present inventive concepts described above, in traffic data management, it is possible to grasp the trend and periodicity of traffic and utilize it for traffic system management in a specific time zone.

For some embodiments, the traffic data shows clear periodic characteristics. Typically, the traffic data can be used in navigation applications or autonomous driving technology.

For example, the present disclosure performs to collect road traffic from location A to location B and model it as a tensor, so that future traffic trend can be predicted. And the present disclosure can capture regions with sudden increases in traffic in real time. This information can be used to re-search alternative routes and to estimate more accurate estimated travel times.

Alternatively, according to the tensor data processing method of the present inventive concepts described above, in banking data management, it is possible to grasp the trend and periodicity of banking transaction and utilize it for electrical banking system management to prevent from abnormal transaction.

For example, the present invention performs to collect users' remittance history or card usage history, model them as tensors and predict usual patterns of user's banking transaction. When a transaction different from the usual banking transaction pattern occurs, it can be estimated as an abnormal transaction. the abnormal transactions can be detected in advance and blocked in real time.

While the present inventive concept has been described with reference to exemplary embodiments thereof, it will be understood by those of ordinary skill in the art that various changes in form and details may be made thereto without departing from the spirit and scope of the present inventive concept.

1. A tensor data processing method comprising:
receiving an input tensor including at least one of an outlier and a missing value, the input tensor being input during a time interval between a first time point and a second time point;
factorizing the input tensor into a low rank tensor to extract a temporal factor matrix;
calculating trend and periodic pattern from the extracted temporal factor matrix;
detecting the outlier which is out of the calculated trend and periodic pattern;
updating the temporal factor matrix except the detected outlier;
combining the updated temporal factor matrix and a non-temporal factor matrix of the input tensor to calculate the real tensor; and
recovering the input tensor by setting data corresponding to a position of the outlier or a position of the missing value of the input tensor from the data of the real tensor as an estimated value.

2. The tensor data processing method of claim 1, wherein the factorization comprises
factorizing into at least one rank-1 tensor on the basis of a predetermined temporal factor factorization model,
wherein the factorized rank-1 tensor includes at least one non-temporal factor matrix and the temporal factor matrix.

3. The tensor data processing method of claim 2, wherein the factorization into the rank-1 tensor extracts a factor matrix that minimizes a cost function of a static tensor factorization model except the missing value from the input tensor for each factor.

4. (canceled)

5. The tensor data processing method of claim 3, wherein the static tensor factorization model initializes each of the factor matrix and the outlier subtensor by the input tensor between the first time point and the second time point, using the static tensor factorization model, and
calculates the trend and periodic pattern, using the initialized static tensor factorization model.

6. The tensor data processing method of claim 5, wherein extraction of the factor matrix updates and extracts the non-temporal factor matrix for each row from an input tensor from which the outlier is removed in an ALS (Alternating Least Square) manner

7. The tensor data processing method of claim 1, wherein the calculation of the trend and the periodic pattern extracts the temporal factor matrix into a level pattern, a trend pattern, and a seasonality pattern on the basis of a temporal factor prediction model.

8. The tensor data processing method of claim 7, wherein the temporal factor prediction model is a Holt-Winter model, which extracts the level pattern, trend pattern, and seasonality pattern on the basis of Equation 2.
lₜ=α(yₜ−sₜ₋ₘ)+(1−α)(lₜ₋₁+bₜ₋₁), (21)
bₜ=β(lₜ−lₜ₋₁)+(1−β)bₜ₋₁, (22)
sₜ=γ(yₜ−lₜ₋₁−bₜ₋₁)+(1−γ)sₜ₋ₘ (23)
(t is a time, m is a period, lₜ is a level vector, bₜ is a trend vector, sₜ is a seasonal vector, and coefficients α, β, γ are real numbers between 0 and 1, which are each of a level smoothness control parameter, a trend smoothness control parameter, and a seasonal smoothness control parameter).

9. The tensor data processing method of claim 1, wherein detection of the outlier detects data which are out of a predetermined range in the input tensor as the outlier tensor in accordance with a 2 sigma rule and excludes the data from the input tensor.

10. The tensor data processing method of claim 8, wherein the updating applies observation data of the input tensor from which the outlier is excluded to the extracted level pattern, trend pattern and seasonality pattern to calculate the temporal factor matrix of the second time point as a real tensor.

11. The tensor data processing method of claim 1, further comprising:
applying the recovered input tensor to the extracted level pattern, trend pattern and seasonality pattern to predict a future input tensor of a third time point.

12. The tensor data processing method of claim 11, further comprising:
comparing the predicted future input tensor with the real input tensor at the third time point to detect a next outlier.

13. (canceled)

14. A tensor data processing method comprising:
receiving an input tensor;
applying to the input tensor to initialize a static tensor factorization model of temporal characteristics;
factorizing the input tensor into a temporal factor matrix and a non-temporal factor matrix on the basis of the static tensor factorization model;
calculating trend and periodic pattern of the temporal factor matrix on the basis of the temporal prediction model;
updating the temporal factor matrix and the non-temporal factor matrix in accordance with a dynamic tensor factorization model;
combining the updated temporal factor matrix and the non-temporal factor matrix to calculate the real tensor; and
detecting and repairing an outlier tensor and a missing value of the input tensor on the basis of the real tensor.

15. The tensor data processing method of claim 14, wherein the input tensor includes the outlier, the missing value, and the real tensor, and
the initialization of the static tensor factorization model initializes each factor matrix and the outlier tensor of the input tensor which is input during a time of at least three times a minimum period of the periodic pattern.

16-18. (canceled)

19. The tensor data processing method of claim 14, wherein the outlier tensor detects data which are out of a range based on a sparsity control parameter among the data obtained by subtracting the real tensor from the input tensor, as the outlier tensor.

20. The tensor data processing method of claim 18, further comprising:
after the updating
updating the trend and the periodic pattern on the basis of the calculated temporal factor matrix and the non-temporal factor matrix.

21. A tensor data processing method comprising:
receiving an input tensor including at least one of an outlier and a missing value, the input tensor being input during a time interval between a first time point and a second time point;
factorizing the input tensor into a low rank tensor to extract each factor matrix;
calculating each data pattern from the extracted first temporal factor matrix;
detecting the outlier which is out of the calculated data pattern from the first factor matrix;
updating the first factor matrix on the basis of the calculated data pattern except the detected outlier;
combining the updated first factor matrix with a remaining second factor matrix of the input tensor to calculate the real tensor (x); and
recovering the input tensor by considering to a position of the outlier or a position of the missing value of the input tensor from the data of the real tensor as an estimated value.

22. The tensor data processing method of claim 21, wherein the extraction of the factor matrix factorizes into at least one rank-1 tensor each including at least one first factor matrix and second factor matrix, on the basis of a predetermined factor factorization model.

23. The tensor data processing method of claim 22, wherein the factorization into the rank-1 tensor extracts a factor matrix that minimizes a cost function of a static tensor factorization model except the missing value from the input tensor for each factor.

24. The tensor data processing method of claim 23, wherein the static tensor factorization model initializes each of the factor matrix and the outlier subtensor with the input tensor between predetermined first time point and second time point, using the static tensor factorization model, and
calculates the data pattern, using the initialized static tensor factorization model.

25. The tensor data processing method of claim 21, further comprising:
applying the recovered input tensor to the extracted data pattern to predict a future input tensor at a third time point after the second time point.
